(19) United States
(12) Patent Application Publication
(10) Pub. No.: US 2012/0159193 A1
(43) Pub. Date: Jun. 21, 2012

(54) SECURITY THROUGH OPCODE RANDOMIZATION

(75) Inventor: Jeremiah C. Spradlin, Woodinville, WA (US)

(73) Assignee: Microsoft Corporation, Redmond, WA (US)

(21) Appl. No.: 12/972,433

(22) Filed: Dec. 18, 2010

(51) Int. Cl. G06F 12/14

(52) U.S. Cl. 713/190

(57) ABSTRACT

An opcode obfuscation system is described herein that varies the values of opcodes used by operating system or application code while the application is stored in memory. The system puts application code through a translation process as the application code is loaded, so that the code sits in memory with an altered instruction set. If new and potentially malicious code is injected into the process, its instruction set will not match that of the translated application code. As time to execute the application code approaches, the system puts the application code through a reverse translation process that converts the application code back to the original opcodes. Any malicious code injected into the process will also undergo the reverse translation, which will have the effect of making the malicious code detectable as invalid or erroneous.

### BACKGROUND

Most computer systems work by providing a central processing unit (CPU) that receives one or more opcodes that perform basic low-level operations. One example is the popular Intel x86 architecture that provides instructions for moving data (e.g., mov, push, pop), mathematical operations on numbers (e.g., add, adc, sub, sbb, div, fdiv, imul), logical operations (e.g., and, or, xor), branching to different execution paths (e.g., jmp, jne, jz, ret), interrupts (e.g., int), and so forth. Compilers convert human-readable source code written by a software developer in a programming language to binary opcodes through the processes of compilation, linking, and assembly to produce executable files. Upon receiving instructions from a user to run an executable file, the operating system provides the binary opcodes to the processor, which carries out the instructions of the program represented by the executable file.

Modern program exploits generally involve getting the CPU to execute instructions other than those originally intended by the application author. This can include injecting new binary code in the form of opcodes into the application's process. Often, this occurs by exceeding the length of a buffer (i.e., a buffer overrun) that has the effect of overwriting a function's return address so that the exit of the function causes control flow to branch to malicious code injected into the buffer. These attacks largely work in a widespread manner because of the predictable nature of the layout of an application program. If a program places data in the same place each time it runs and processes data in the same way, then an attacker can be reliably assured that the same attack vectors will work on many computer systems.

These attacks are all predicated on the ability of the attacker to understand and anticipate the behavior of the system. The most basic behavior the attacker needs to understand is the machine instruction code set (i.e., opcodes), and what instructions to execute in order to obtain the desired behavior. A large contributing factor to why many types of computing devices have not been hacked as frequently as personal computers is simply their use of a different instruction set. For example, many mobile phones use ARM processors or others with non-x86 instruction sets. Most solutions that involve preventing the execution of malicious code rely on prevention during development, software detection of malicious code (e.g., anti-virus scanning), or other means of managing the state of the process (e.g., memory managers that randomize the heap layout and other modifications). While these methods have met some success, malicious code execution continues to be a significant problem.

### SUMMARY

An opcode obfuscation system is described herein that varies the values of opcodes used by operating system or application code while the application is stored in memory. The period during which an application is stored in memory and prior to execution is the most common time for malicious code to be injected. The system puts application code through a translation process as the application code is loaded, so that the code sits in memory with a random instruction set. If new and potentially malicious code is injected into the process, its instruction set will not match that of the translated application code. As time to execute the application code approaches, the system puts the application code through a reverse translation process that converts the application code back to the original opcodes. Any malicious code injected into the process will also undergo the reverse translation, which will either detect the invalid opcodes, or will have the effect of making the malicious code perform an unknown and likely nonsensical set of instructions, likely making the CPU fault. Code composed of unstructured opcodes does not generally execute very long before causing an interrupt or trap of some sort that is caught by the operating system, which terminates the process. Thus, the application code will run well while the malicious code will cause noticeable errors.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a block diagram that illustrates components of the opcode obfuscation system, in one embodiment.

FIG. 2 is a flow diagram that illustrates processing of the opcode obfuscation system to translate application code as it is loaded from storage into an obfuscated domain for holding prior to execution, in one embodiment.

FIG. 3 is a flow diagram that illustrates processing of the opcode obfuscation system to reverse-translate application code at execution time from an obfuscated domain to a native domain, in one embodiment.

FIG. 4 is a block diagram that illustrates three phases of a module containing executable code during operation of the opcode obfuscation system, in one embodiment.

FIG. 5 is a block diagram that illustrates the protection provided by the opcode obfuscation system and where protection can occur, in one embodiment.

### DETAILED DESCRIPTION

An opcode obfuscation system is described herein that varies the values of opcodes used by operating system or application code while the application is stored in memory. The period during which an application is stored in memory and prior to execution is the most common time for malicious code to be injected into that memory. The opcode obfuscation system puts application code through a translation process as the application code is loaded, so that the code sits in memory with a random or pseudorandom instruction set. If new and potentially malicious code is injected into the process, its instruction set will not match that of the translated application code. As time to execute the application code approaches, the opcode obfuscation system puts the application code through a reverse translation process that converts the application code back to the original opcodes.

Any malicious code injected into the process will also undergo this translation, which will have the effect of making the malicious code perform an unknown and likely nonsensical set of instructions, or will make the CPU fault. Code composed of unstructured opcodes does not generally execute very long before causing an interrupt or trap of some sort that is caught by the operating system, which terminates the process. The reverse translation may occur in hardware or software. For example, the processor may be modified to perform the translation just before execution. In a simple implementation, the translation and reverse translation components may share a numeric key that the system puts through an exclusive-OR logical operation with the opcodes to create an easily reversible but effective translation process. In this way, the application code will run well while the malicious code will cause noticeable errors. There are many possible means to detect whether malicious code has been injected besides random or nonsensical opcodes. For example, the reverse translation component may generate a fault if an invalid randomized opcode is found. The component may also validate the arguments for any given opcode and fault if invalid arguments are encountered.

By randomizing the actual values of the machine opcodes, as stored in memory, the opcode obfuscation system prevents predictable machine behavior that an attacker can exploit. A side effect is that self-modifying code is also affected, although less common. The randomization occurs at least once in the machine's lifetime, but may also occur per-boot, or even per-process, depending upon the hardware design. Ideally, the opcode randomization will result in an orthogonal result set, so no collisions occur (e.g., X∩X′=Ø). The smaller the resulting set of common opcodes between the two sets, the more likely the reverse-translation may pre-emptively detect a malicious code. In some embodiments, the opcode obfuscation system randomizes the machine opcodes, and uses a look up table to translate the shifted opcodes to the opcodes that are native to the CPU. The system can apply this technology via the operating system on a process-by-process basis. For example, the system may incur a performance penalty such that the system implementer chooses to apply the system to more vulnerable processes but not apply the system to trusted or performance-critical processes. Thus, the opcode obfuscation system protects computing devices and selected processes from malicious code and provides a safer execution environment for applications.

In some embodiments, the opcode obfuscation system leverages modifications to both computer hardware and operating systems to carry out the application process described herein. Select modifications are described further in the following paragraphs. In addition, there are many potential variations on the potential implementations, depending on the level of protection suited to a particular implementation's goals (e.g., whether only specific processes will be protected or whether all executable code running on the machine will be protected).

In a first variation, all executable code is protected by the opcode obfuscation system. In this instance, any executable page in memory is protected, and all code loaded into executable pages goes through the translation process to alter the opcodes. Modern CPUs provide designations for pages in memory that determine whether particular pages can be executed (e.g., the NX “no execute” bit used for x86 processors). In circumstances where hardware support is unavailable, many operating systems have been modified to provide similar support in the memory management unit (MMU) that allocates and manages virtual memory pages. This variation provides simplicity as all code is protected, but may also incur performance tradeoffs that are unacceptable for some computing devices.

In a second variation, only specifically marked processes are protected by the opcode obfuscation system. In this instance, specific processes are marked as protected, and the pages used to store the opcodes are marked as “protected execute” or another designation that can be interpreted by the CPU and/or operating system and MMU. As previously noted, there is some cost associated with translating the opcodes from their native domain to the altered domain and back again. By only protecting specific processes, implementers can leverage the protection of the opcode obfuscation system wherever useful (e.g., when unvalidated input is processed), but avoid the performance penalty in other locations.

The protection described herein can occur in various locations, such as in the CPU when there is no CPU cache, in a cache controller of the CPU when there is a CPU cache, in the CPU or cache controller when there is an off-CPU cache, in an MMU, and so forth. In the case where a cache controller protects code, when the code is loaded into memory the operating system invokes a routine that instructs the cache controller to apply the opcode mapping between the native and altered opcode domains. Conversely, as the caching code in the CPU loads memory, the cache controller will perform the translation back from the altered to the native domain. Thus, within the CPU cache the instructions will be in the native domain. Any code loaded in a non-official manner will undergo the second translation but not the first, leading to unpredictable operation. This solution allows existing branch prediction code within the CPU cache to be easily maintained.

In the case where the CPU protects code, the executable code is maintained in the altered domain, even within the CPU L2 cache, and the translation is done either in the L1 or directly before evaluation by the processor. The processor is responsible for loading the executable code into memory and as such, may enforce other constraints (such as specific privilege level sufficient to load executable code). This variation provides a higher level of security, in that the executable code is only in its native domain for a short period, but involves potentially expensive reworking or performance degradation of the CPU.

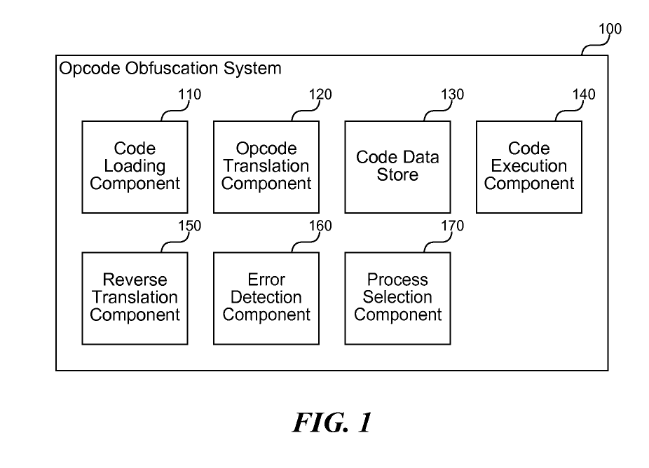

FIG. 1 is a block diagram that illustrates components of the opcode obfuscation system, in one embodiment. The system 100 includes a code loading component 110, an opcode translation component 120, a code data store 130, a code execution component 140, a reverse translation component 150, an error detection component 160, and a process selection component 170. Each of these components is described in further detail herein.

The code loading component 110 loads executable code from a storage location into a pre-execution storage area. The pre-execution storage area may include main memory of a personal computer, one or more cache levels, and so forth. For devices with solid-state persistent storage, the component 110 may precache or store part of the executable code in the solid-state storage device (e.g., MICROSOFT™ WINDOWS™ Ready Boost). The code loading component 110 receives a request to load executable code from an operating system shell or loader and identifies one or more modules associated with the executable code. In some embodiments, the code loading component 110 may be built into the loader of an operating system to intercept all requests to load application code, or into a basic input output system (BIOS) or other firmware layer, such as extensible firmware interface (EFI).

The opcode translation component 120 translates the loaded executable code from a native domain to an obfuscated domain. The code translation modifies at least opcodes and potentially other data in the instruction stream of the executable code to produce a difficult to predict alteration of the executable code. In some embodiments, the system may choose a random number or cryptographic salt at each boot of the computer system or as each process starts and use that value to roll the opcodes in a certain manner (e.g., a logical XOR or other reversible operation). Even if a computer system only selects a random number when the operating system is installed, the fact that each computer system has a potentially different number used to obfuscate opcodes frustrates malicious code authors and makes it difficult to install code on the computer system that will do any harm. The strength of the random number generator, the key size, and system entropy will determine the actual number of machines that share the same altered domain.

The code data store 130 stores loaded and translated executable code for later execution. The code data store 130 may include one or more in-memory data structures, files, file systems, hard drives, databases, cloud-based storage services, or other facilities for storing data. Computer systems today run many types of application code, including managed application code that goes through a just-in-time (JIT) compilation after installation on a computing device on which the code will run. For example, MICROSOFT™ NET produces a global assembly cache (GAC) of modules that have been compiled from intermediate language (IL) code and are ready to be loaded and run on the computer system. In some embodiments, the opcode translation component 120 may operate at this phase to obfuscate program modules as they are JIT compiled. More traditional native application code may be translated in memory each time it is requested to load or the system may cache translated versions of the native application code. Some operating systems today produce pre-fetched memory snapshots of modules that speed up execution (e.g., MICROSOFT™ WINDOWS™ SuperFetch), and these features can be modified to perform and cache the translation described herein. This saves time during process execution, as a translated version of the binary code may already be available in the cache.

The code execution component 140 receives instructions to execute identified in-memory program code. The component 140 may operate as part of an operating system's memory manager or within CPU controller or cache controller that loads executable pages from memory into a CPU cache slightly prior to their time to execute. The code execution component 140 may access translated executable code from the code data store 130 and invoke the reverse translation component 150 to reverse the translation. If the translated code has been modified since the time it was translated, such as by the injection of malicious code due to a buffer overrun, then the reverse translation component 150 will convert the original program code into native domain opcodes and the malicious code into gibberish, or error-causing opcodes.

The reverse translation component 150 reverses the translation of the opcode translation component 120 to convert obfuscated domain executable code into native domain executable code that a processor can execute. The reverse translation component 150 may operate within a CPU to convert an incoming instruction stream, in an MMU, in various components of an operating system, and so forth. The reverse translation component 150 may receive the random number or cryptographic salt used by the original translation so that the translation process can be reversed. In the case of a logical XOR scrambling of opcodes, the reverse translation simply performs the same operation again and the output is the original set of opcodes. In more sophisticated implementations, the opcode translation component 120 and reverse translation component 150 may employ a public/private key pair or other matched set of keys to translate and reverse-translate the opcodes.

The error detection component 160 detects erroneous opcodes in an execution stream. The opcodes may be erroneous because they are invalid, because they do not fit in a particular context, because they access data for which the instruction does not have access (e.g., access violation), because they cause an interrupt or overflow, and so forth. The reverse translation process causes any malicious code placed in the executable space of an application after the application was initially loaded to be translated into random or nonsensical opcodes, or to cause a fault. Because of the precise and carefully crafted nature of normal program opcodes, random opcodes will quickly cause an error of some type or another or may be easily detectable as being out of range or invalid. At that point, the error detection component 160 detects the error and takes appropriate action, such as terminating the application process. Detecting the error may occur through normal CPU and operating system mechanisms for trapping errant code and avoiding damage to data.

The process selection component 170 selects to which processes to apply the opcode translation component 120 to produce obfuscated opcodes. In some embodiments, the system 100 does not apply the translation to all processes, and the process selection component 170 determines whether a given process will receive translation. The system may receive configuration information from a user or operating system vendor that identifies processes for which to translate opcodes. In some embodiments, an operating system vendor may sign binary code allowed to run on a platform and subject unsigned or untrusted binary code to translation while trusted code is not. As another example, the system 100 may perform translation only on code that does or does not interact with a network. These and other variations can be used with the system 100 to achieve an appropriate level of security and performance.

The computing device on which the opcode obfuscation system is implemented may include a central processing unit, memory, input devices (e.g., keyboard and pointing devices), output devices (e.g., display devices), and storage devices (e.g., disk drives or other non-volatile storage media). The memory and storage devices are computer-readable storage media that may be encoded with computer-executable instructions (e.g., software) that implement or enable the system. In addition, the data structures and message structures may be stored or transmitted via a data transmission medium, such as a signal on a communication link. Various communication links may be used, such as the Internet, a local area network, a wide area network, a point-to-point dial-up connection, a cell phone network, and so on.

Embodiments of the system may be implemented in various operating environments that include personal computers, server computers, handheld or laptop devices, multiprocessor systems, microprocessor-based systems, programmable consumer electronics, digital cameras, network PCs, minicomputers, mainframe computers, distributed computing environments that include any of the above systems or devices, set top boxes, systems on a chip (SOCs), and so on. The computer systems may be cell phones, personal digital assistants, smart phones, personal computers, programmable consumer electronics, digital cameras, and so on.

The system may be described in the general context of computer-executable instructions, such as program modules, executed by one or more computers or other devices. Generally, program modules include routines, programs, objects, components, data structures, and so on that perform particular tasks or implement particular abstract data types. Typically, the functionality of the program modules may be combined or distributed as desired in various embodiments.

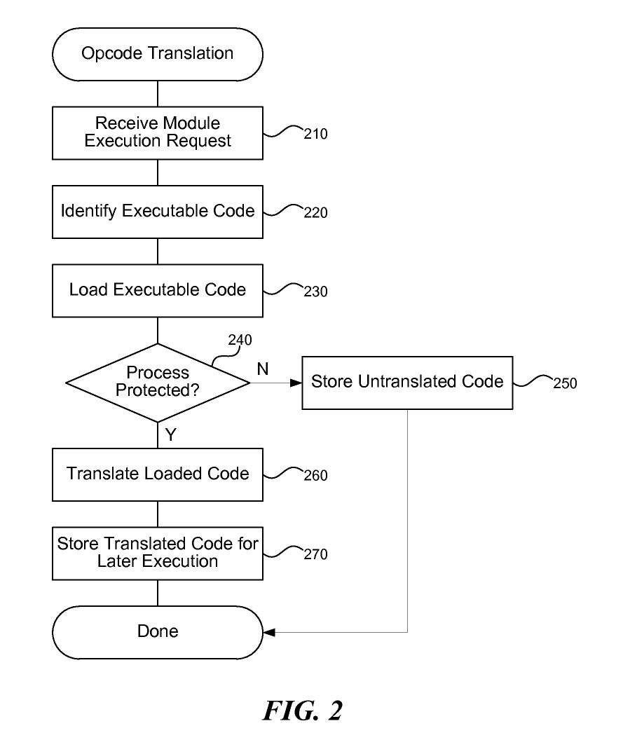

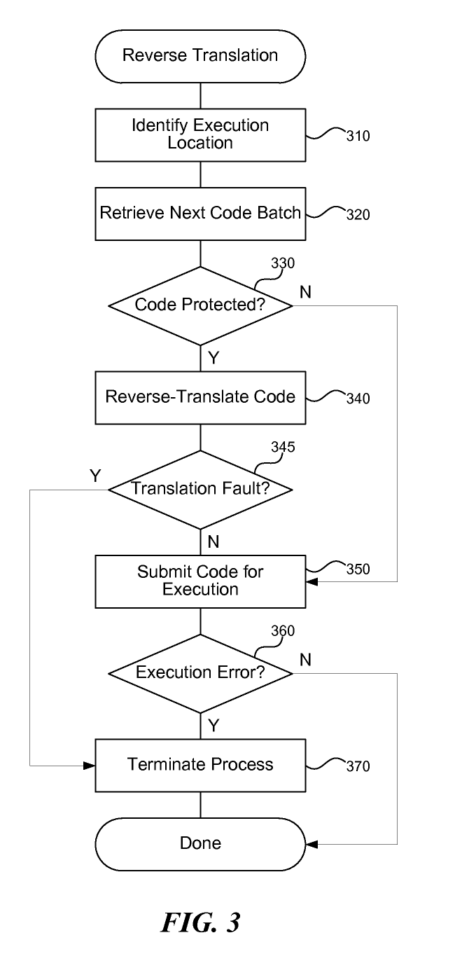

FIG. 2 is a flow diagram that illustrates processing of the opcode obfuscation system to translate application code as it is loaded from storage into an obfuscated domain for holding prior to execution, in one embodiment. The processes described in FIGS. 2 and 3 typically occur in succession, with some amount of time passing between the processes. During this time, application code typically sits in memory where it is vulnerable to interference by malicious hacking attempts. The translation process described with reference to FIG. 2 renders any hacking attempts ineffective due to the reverse translation of FIG. 3 that will have the net effect of making the original application code execute normally and any malicious code perform unexpected operations that cause detectable errors.

Beginning in block 210, the system receives a module execution request that specifies one or more executable modules to load into a process for execution. Operating systems typically define a binary module format for executable modules, such as the Portable Executable (PE) format, that contain executable binary code. The modules may statically reference other modules (e.g., the import table of a PE image), and dynamically load other modules (e.g., by calling LoadLibrary/GetProcAddress on the MICROSOFT™ WIN32™ platform). Binary code loaded in this manner can typically be trusted to be harmless or protected by other mechanisms, such as code signing, versus binary code loaded outside of this process during the execution of an application.

Continuing in block 220, the system identifies executable code in the specified executable modules. In most cases, the well-known format of the module will indicate the portions of the module that contain executable code. For example, a PE image often contains a “.text” section or a header that specifies an entry point to executable code within the module. For precached or JIT compiled code, the computer system may contain debugging symbols or other metadata that identifies executable regions.

Continuing in block 230, the system loads the identified executable code. Operating system loaders typically handle the loading of executable code, including handling any statically linked modules, binary relocations to avoid address space collisions, fix-ups of absolute addresses in the instruction stream, and so forth. The opcode obfuscation system hooks or modifies the loader process to insert the step of translating the opcodes of the executable code from a native domain to an obfuscated domain. As a simple example, the system may add 0x20 to each opcode so that 0x55 (PUSH EBP, a common setup of an x86 stack frame at entry to a function) becomes 0x75 (which would be a JNE instruction if executed).

Continuing in decision block 240, if the system determines that a current process will be protected with opcode translation, then the system continues at block 260, else the system continues at block 250. Continuing in block 250, the system stores the loaded, untranslated executable code for normal execution. The system may store the code in memory in previously allocated page marked for execution. After block 250, the system completes. Continuing in block 260, the system translates the loaded executable code from a native domain to an obfuscated domain. In some embodiments, the system disassembles the executable code to identify each opcode, and then scrambles the opcodes using a well-defined and reversible process that is nevertheless difficult for malicious code to predict. Because malicious code cannot correctly scramble itself, the unscrambling process described with reference to FIG. 3 will render the malicious code benign for its original purpose.

Continuing in block 270, the system stores the translated executable code in preparation for execution. The system may store the executable code in main memory, in a fast memory cache, or in another location where code ready to execute is stored. When the time comes to execute the code, the system reverses the translation process as described with reference to FIG. 3. After block 270, these steps conclude.

FIG. 3 is a flow diagram that illustrates processing of the opcode obfuscation system to reverse-translate application code at execution time from an obfuscated domain to a native domain, in one embodiment. Beginning in block 310, the system identifies a current execution location of the application code. The identification may include receiving notification that an executable page is being requested from memory, following the instruction pointer of a CPU, operating within the CPU to pre-process an instruction stream, and so forth. The system waits to reverse-translate the opcodes of code stored in memory until a sufficiently close time to the point the opcodes will be executed to reduce a window of time that malicious code can infiltrate legitimate application code.

Continuing in block 320, the system retrieves a next batch of code to be executed based on the identified current execution location. The batch may include a memory page, function, next N opcodes, or other subset of code. For example, the system may operate within an operating system memory manager to detect accesses of executable pages of memory or within a CPU to prepare an instruction stream for execution.

Continuing in decision block 330, if the system determines that the next batch of code has been translated into an obfuscated domain, then the system continues at block 340, else the system continues at block 350. Non-translated code is allowed to execute as normal unless the system is setup to translate all code. The opcode obfuscation system allows an operating system or application to request that only some code be secured by the process described herein and the system conditionally reverses the process based on whether the code is marked as having undergone the initial translation described with reference to FIG. 2.

Continuing in block 340, the system reverse-translates the retrieved batch of code from an obfuscated domain to a native domain executable by a processor. For example, the native domain may include the Intel x86 instruction set while the obfuscated domain may include a random perturbation of the x86 instruction set. Reverse translating applies a reverse operation to the previously applied translation and for legitimate application code produces binary code that is ready to execute by the processor. For malicious code that was not present at the time of the original translation, the reverse-translation process produces unpredictable, error-prone binary code that is expected to quickly produce one or more detectable errors. Continuing in decision block 345, if the system detects a fault during the reverse translation, then the system jumps to block 370 to terminate the process, else the system continues at block 350.

Continuing in block 350, the system submits the reverse translated code for execution to the processor. If the code is normal application code, then it will execute as designed by the program author to perform whatever purpose it was intended. If the code contains malicious program code, however, that was scrambled by the reverse-translation process, then it may execute for several instructions before producing some type of error (e.g., an access violation, range error, overflow, and so forth).

Continuing in decision block 360, if the system detects an execution error then the system continues at block 370, else the system completes. The execution error may include one or more anomalies trapped by a processor or operating system, such as an interrupt, access violation, protection fault, and so forth. In some embodiments, the system reverse-translates executable code using a lookup table. The system may substitute a well-known error instruction for any requests to translate invalid opcodes. In most instruction sets, there exist opcodes that are unused, deprecated, reserved for future use, and so forth. The system can translate such codes into, for example, an interrupt, to further insure that attempts to execute scrambled malicious code will produce an exception or other execution-halting result.

Continuing in block 370, the system terminates the execution of the application code. The system may display an error to the user, offer to attach a debugger, or submit an automated error report to a central service for further processing. In any event, the application code does not continue to run very long after it has been compromised, ensuring that the malicious code is unable to do any harm. After block 370, these steps conclude.

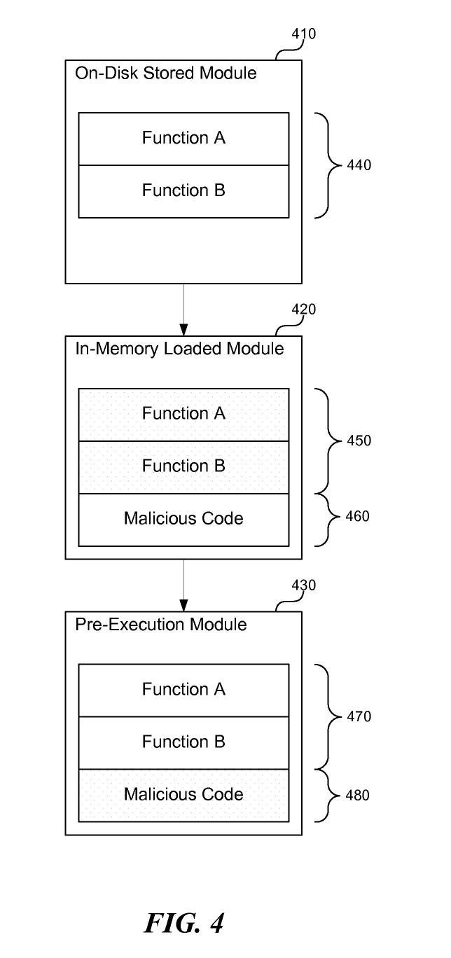

FIG. 4 is a block diagram that illustrates three phases of a module containing executable code during operation of the opcode obfuscation system, in one embodiment. The first phase 410 shows the on-disk stored version of the module. The module includes one or more functions 440 or other executable code for carrying out the purpose of the module. The opcode obfuscation system loads the module into memory to produce the second phase 420. The hatched areas of the diagram illustrate areas that are translated or scrambled using the techniques described herein. As shown in the second phase 420, the functions 450 were translated at the time the module was loaded. Later, the malicious code 460 injected itself into the module, through either a buffer overrun or other attack vector. Because the malicious code 460 was not around at the time the module was loaded, it is not translated using the techniques described herein. The third phase 430 illustrates the module in its condition just prior to execution. It may be held in a CPU cache, memory cache, or other location just prior to executing within the CPU. The system has reversed the translation process on the executable code of the module, with the effect that the functions 470 are back in their original pre-translated state, but the malicious code 480 has been scrambled. As the module executes, the functions 470 will work as normal, but the malicious code 480 will produce unintended results including one or more errors. In this way, the execution of the process is made safer by the opcode obfuscation system.

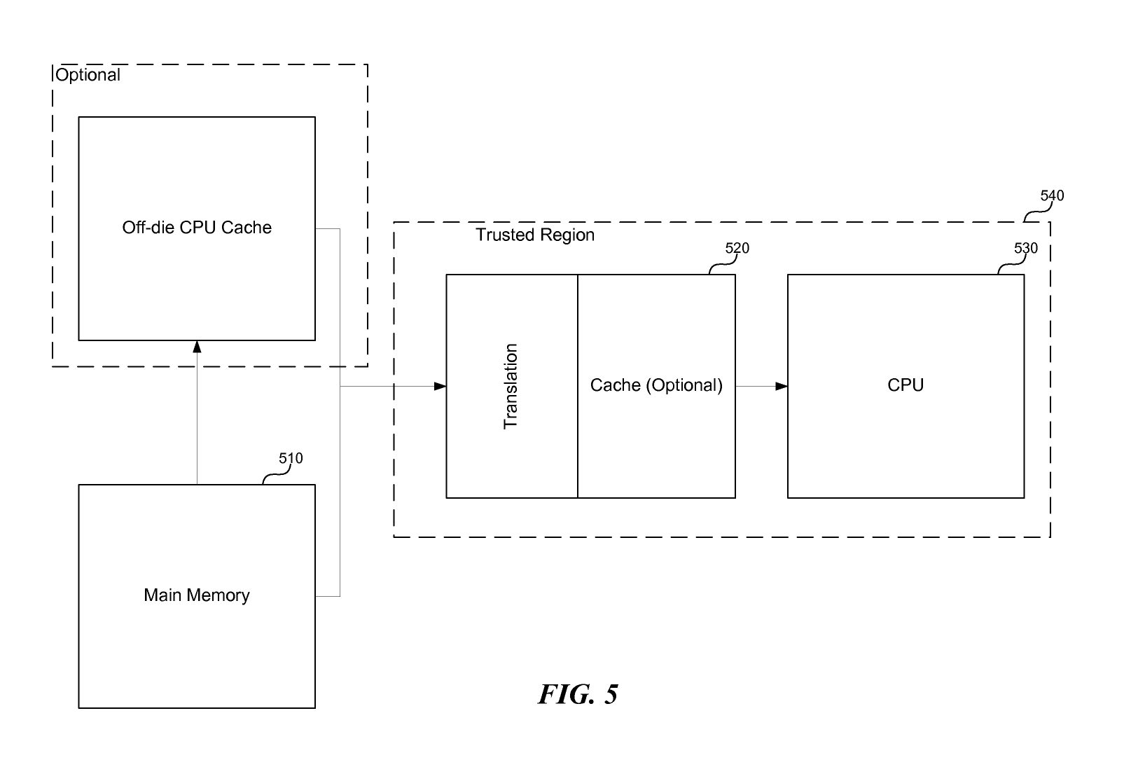

FIG. 5 is a block diagram that illustrates the protection provided by the opcode obfuscation system and where protection can occur, in one embodiment. The diagram includes a main memory 510, a pre-CPU cache 520, and a CPU 530 (that may also have one or more internal layers of cache). In the embodiment shown, the system translates opcodes of code before loading that code into main memory 510, and a cache controller or other entity reverse translates the opcodes as code moves from main memory 510 to the cache 520. Thus, a conceptual trusted region 540 exists around the cache 520 and CPU 530. Note that the system can be implemented in various embodiments to locate the trusted region 540 in a different manner. For example, in some embodiments the trusted region 540 may include the CPU 530 but not the cache 520.

In some embodiments, the opcode obfuscation system translates data as well as opcodes. Some instructions sets make identifying opcodes more difficult than others do. For example, complex instruction set architectures (CISC) often include variable length opcodes, so that it is difficult without disassembly to tell where one code stops and another starts. In such cases, the system may elect to translate the entire instruction stream, including any data such as jump addresses, operand values, and so forth. There is no harm in also translating the data as it will be translated back by the reverse-translation process, other than the potential additional time incurred. However, mapping values is a relatively fast operation.

In some embodiments, the opcode obfuscation system can locate the reverse-translation phase at various levels. For example, the reverse translation could happen in main memory, in an MMU, in L2 cache, in L1 cache, or in the CPU itself. A system implementer can choose the location based on a target level of security and cost of placement at various stages. In general the later the translation occurs and closer to the CPU, the more secure the process will be. However, later stage translations also involve hardware modifications, such as a revised CPU, that may be costly. Similarly, the forward translation can occur at various stages, such as on disk, during load, in main memory, and so forth. In general, the translation will occur before the application code sits in memory awaiting execution.

From the foregoing, it will be appreciated that specific embodiments of the opcode obfuscation system have been described herein for purposes of illustration, but that various modifications may be made without deviating from the spirit and scope of the invention. Accordingly, the invention is not limited except as by the appended claims.

I/We claim:

1. A computer-implemented method for translating application code as it is loaded from storage into an obfuscated domain for holding prior to execution, the method comprising:
receiving a module execution request that specifies one or more executable modules to load into a process for execution;
identifying executable code in the specified executable modules;
loading the identified executable code;
upon determining that the process will be protected with opcode translation, translating the loaded executable code from a native domain to an obfuscated domain; and
storing the translated executable code in preparation for execution,
wherein the preceding steps are performed by at least one processor.

2. The method of claim 1 wherein receiving the module execution request comprises identifying a stored executable module that contains executable binary code.

3. The method of claim 1 wherein receiving the module execution request comprises identifying one or more statically linked modules referenced by a main module and loading the statically linked modules.

4. The method of claim 1 wherein identifying executable code comprises determining a location of executable code in a module based on the module format.

5. The method of claim 1 wherein identifying executable code comprises loading debugging symbols or other metadata that identifies executable regions.

6. The method of claim 1 wherein loading the executable code comprises hooking or modifying an operating system loader process to insert the step of translating the opcodes of the executable code from a native domain to an obfuscated domain.

7. The method of claim 1 further comprising, upon determining that the process will not be protected with opcode translation, storing the loaded, untranslated executable code for normal execution.

8. The method of claim 1 wherein translating the executable code comprises replacing each opcode with a new opcode identified in a lookup table.

9. The method of claim 1 wherein translating the executable code comprises identifying each opcode and scrambling the identified opcodes using a well-defined and reversible process that is difficult for malicious code to predict.

10. The method of claim 1 wherein storing the translated executable code comprises storing the executable code in main memory, and upon detecting upcoming execution of the code, reversing the translation process to convert the module code to its original form and any malicious code into an invalid form.

11. A computer system for providing application process security through opcode randomization, the system comprising:
a processor and memory configured to execute software instructions embodied within the following components;
a code loading component that loads executable code from a storage location into a pre-execution storage area;
an opcode translation component that translates the loaded executable code from a native domain to an obfuscated domain;
a code data store that stores loaded and translated executable code for later execution;
a code execution component that receives instructions to execute identified in-memory program code;
a reverse translation component that reverses the translation of the opcode translation component to convert obfuscated domain executable code into native domain executable code that a processor can execute; and
an error detection component that detects erroneous opcodes in an execution stream and prevents malicious or modified code from executing correctly.

12. The system of claim 11 wherein the code loading component pre-execution storage area includes main memory of a personal computer, and wherein the component receives a request to load executable code from an operating system shell or loader and identifies one or more modules associated with the executable code.

13. The system of claim 11 wherein the opcode translation component works with a native domain that contains opcodes for a processor instruction set and the obfuscated domain contains detectably erroneous opcodes.

14. The system of claim 11 wherein the opcode translation component modifies at least opcodes in an instruction stream of the executable code to produce a difficult to predict alteration of the executable code, and operates during loading of a firmware layer for the computer system.

15. The system of claim 11 wherein the code data store includes an assembly cache for just-in-time (JIT) compiled executable modules.

16. The system of claim 11 wherein the code execution component operates as part of an operating system's memory manager that loads executable pages from memory into a CPU cache prior to each page's time to execute.

17. The system of claim 11 wherein the code execution component accesses translated executable code from the code data store and invokes the reverse translation component to reverse the translation, wherein if the translated code has been modified since the time it was translated, then the reverse translation component will convert original program code into native domain opcodes and any malicious code into error-causing opcodes.

18. The system of claim 11 wherein the reverse translation component operates within the processor to convert an incoming instruction stream to untranslated executable code.

19. The system of claim 11 further comprising a process selection component that selects to which processes to apply the opcode translation component to produce obfuscated opcodes, wherein the system does not apply the translation to all processes, and the process selection component determines whether a given process will receive translation.

20. A computer-readable storage medium comprising instructions for controlling a computer system to reverse-translate application code at execution time from an obfuscated domain to a native domain, wherein the instructions, upon execution, cause a processor to perform actions comprising:
identifying a current execution location of the application code;
retrieving a next batch of code to be executed based on the identified current execution location;
upon determining that the next batch of code has been translated into an obfuscated domain, reverse-translating the retrieved batch of code from an obfuscated domain to a native domain executable by a processor;
submitting the reverse translated code for execution to the processor;
upon detecting an execution error based on an incorrect opcode, terminating the execution of the application code.
